(19) United States
(12) Patent Application Publication
(10) Pub. No.: US 2022/0101146 A1
(43) Pub. Date: Mar. 31, 2022

(54) NEURAL NETWORK TRAINING WITH BIAS MITIGATION

(71) Applicant: Affectiva, Inc., Boston, MA (US)

(72) Inventors: Rana el Kaliouby, Milton, MA (US); Sneha Bhattacharya, Cambridge, MA (US); Taniya Mishra, New York, NY (US); Shruti Ranjalkar, Boston, MA (US)

(73) Assignee: Affectiva, Inc., Boston, MA (US)

(21) Appl. No.: 17/482,501

(22) Filed: Sep. 23, 2021

Related U.S. Application Data
(60) Provisional application No. 63/083,136, filed on Sep. 25, 2020.

(51) Int. Cl. G06N 3/08; G06N 3/04

(52) U.S. Cl. CPC G06N 3/088; G06N 3/0454

(57) ABSTRACT

Techniques for machine learning based on neural network training with bias mitigation are disclosed. Facial images for a neural network configuration and a neural network training dataset are obtained. The training dataset is associated with the neural network configuration. The facial images are partitioned into multiple subgroups, wherein the subgroups represent demographics with potential for biased training. A multifactor key performance indicator (KPI) is calculated per image. The calculating is based on analyzing performance of two or more image classifier models. The neural network configuration and the training dataset are promoted to a production neural network, wherein the promoting is based on the KPI. The KPI identifies bias in the training dataset. Promotion of the neural network configuration and the neural network training dataset is based on identified bias. Identified bias precludes promotion to the production neural network, while identified non-bias allows promotion to the production neural network.

### RELATED APPLICATIONS

This application claims the benefit of U.S. provisional patent application “Neural Network Training with Bias Mitigation” Ser. No. 63/083,136, filed Sep. 25, 2020.

The foregoing application is hereby incorporated by reference in its entirety.

### FIELD OF ART

This application relates generally to machine learning, and more particularly to neural network training with bias mitigation.

### BACKGROUND

Patterns of speech such as tone, volume, and cadence are inherent within effective human communication. The facial expressions that accompany the patterns of speech further communicate critical information. These speech patterns and facial expressions arise while the interhuman communication is taking place. The facial expressions occur at times consciously and at other times subconsciously, depending on a particular facial expression and a context of the conversation. The information that is conveyed by the facial expressions of the speaker and the listener provide basic yet essential guidance about the participants, such as mental states, cognitive states, moods, emotions, etc. The facial expressions of the speaker and the listener are formed by physical movements or positions of various facial muscles. These muscle movements and muscle positions form the facial expressions that convey such information as the emotions of the speaker and the listener. The emotions that are communicated can range from sad to happy, angry to calm, and disinterested to engaged, among many others. The emotions create the facial expressions of anger, fear, disgust, or surprise, among many others.

The facial expressions of a person can be captured and analyzed for a wide range of purposes. The purposes often include implementation of commonly used applications such as identification of a person, facial recognition, and determination of emotions and mental states associated with the person. The mental states, which are determined based on the facial expression capture and analysis, include frustration, ennui, confusion, cognitive overload, skepticism, delight, satisfaction, calmness, stress, and many others. Similarly, the sound of the human voice can be captured and analyzed to detect and identify vocal characteristics or cues that support human communication. The human voice further conveys critical information relating to mental states, moods, emotions, etc. In a manner analogous to facial expression capture and analysis, mental state determination can be based on capture and analysis of voice characteristics including timbre, prosody, vocal register, vocal resonance, pitch, loudness, speech rate, and language content. Voice cues are often referred to as paralanguage cues. Non-verbal communication also occurs between and among people. Nonverbal communication supplements and enhances verbal communication, and can be categorized as visual cues, distance cues, voice cues, and touch cues. Visual cues often include body language and facial expressions. An angry face and a smiling face convey very different messages. Physical distance cues are also informative. Towering over another person, or being “in their face”, threatens and intimidates the person who is on the receiving end. On the other hand, sitting with the person conveys reassurance. Other senses also contribute to human communication. A reassuring touch or various haptic cues can also be used for effective, nonverbal communication.

### SUMMARY

In disclosed techniques, machine learning is accomplished using a neural network with bias mitigation. The neural network can include a deep learning neural network, where the deep learning neural network can be trained by providing a training dataset for processing by the deep learning neural network. The data that is provided to the neural network can include images, where the images can include facial images. The facial images can represent one or more demographic groups, where the demographic groups can be based on age bands; facial hair (or lack thereof); ethnicity; gender; facial coverings such as eyeglasses, an eye patch, or a veil; etc. In order to identify whether the training dataset is biased or non-biased, the bias or non-bias of the test dataset and be measured. A bias can include enhanced or improved performance for an age band, a racial group, a gender or gender identity, and so on. Bias (or non-bias) in the training dataset can be identified by calculating a multifactor key performance indicator (KPI) per image in the training dataset. The calculating the multifactor KPI can be based on analyzing performance of two or more image classifier models. Once trained, the neural network and training dataset can be promoted to a production neural network, based on the identified bias or the identified non-bias. Identified bias can preclude promotion to the production neural network, while identified non-bias can allow promotion to the production neural network. To mitigate bias within the neural network and the training dataset, the neural network training dataset can be augmented with additional images. The additional images can include real images, where the additional images can be chosen based on a specific demographic parameter, can contain a specific facial characteristic such as a facial expression, or can contain a specific image characteristic. The specific image characteristic can include lighting, focus, facial orientation, or resolution. The additional images can further include synthetic images, where the synthetic images can be generated using a generative adversarial network (GAN). The synthetic images can expand a number of images for an age band, demographic parameter, etc.

Traditionally, training data is obtained through the laborious efforts of human coders who determine expected inferences about the data based on analysis and characterization of the data. The training data is then applied to a neural network to train the network. When the neural network makes inferences about the training data that “match” those of the human coders, then the neural network can be considered trained. A GAN is used to expand and augment the amount of training data that is used to train a neural network. A GAN network, as discussed herein, is based on two neural networks: a generator and neural network and a discriminator neural network. The generator neural network attempts to create data, called synthetic data, which is able to fool a discriminator neural network into inferring that the created data is real. The data that is created or synthesized comprises synthetic facial images. In the synthetic facial images, facial lighting and facial expressions have been generated, enhanced, or altered. The discriminator attempts to detect all synthetic data and labels the synthetic data as fake. These adversarial roles of the generator and discriminator enable improved generation of synthetic data. The synthetic data is used to enhance training of the machine learning neural network.

The neural network training can be based on adjusting various weights and biases associated with layers, such as hidden layers, within the neural network. The results of the neural network training based on the training dataset can be enhanced by augmenting the training data with the synthetic data. The synthetic data can thus be used to further train the neural network, or can be used to train an additional neural network such as a production neural network. The training can be based on determinations that include true/false, real/fake, and so on. The trained neural network can be applied to a variety of analysis tasks including analysis of facial elements, facial regions, facial expressions, cognitive states, mental states, emotional states, moods, and so on.

A computer-implemented method for machine learning is disclosed comprising: obtaining facial images for a neural network configuration and a neural network training dataset, wherein the neural network training dataset is associated with the neural network configuration; partitioning the facial images into multiple subgroups, wherein the multiple subgroups represent demographics with potential for biased training; calculating a multifactor key performance indicator (KPI) per image, wherein the calculating is based on analyzing performance of two or more image classifier models; and promoting the neural network configuration and the neural network training dataset to a production neural network, wherein the promoting is based on the multifactor key performance indicator. In some embodiments, the multifactor key performance indicator (KPI) identifies bias in the training dataset. In some embodiments, identified bias precludes promotion to the production neural network. In some embodiments, an absence of identified bias allows promotion to the production neural network.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for neural network training with bias mitigation.

FIG. 2 is a flow diagram for augmenting.

FIG. 3 shows a system block diagram for bias mitigation.

FIG. 4A illustrates an example F1 score.

FIG. 4B illustrates an additional example F1 score.

FIG. 5 shows an overall ROC-AUC plot for emotions.

FIG. 6 illustrates example output for a classifier across age bands.

FIG. 7 is an example showing a convolutional neural network.

FIG. 8 illustrates a bottleneck layer within a deep learning environment.

FIG. 9 shows data collection including devices and locations.

FIG. 10 is a system for machine learning.

### DETAILED DESCRIPTION

In the disclosed techniques, machine learning is based on neural network training with bias mitigation. Neural networks, such as neural networks for machine learning, deep learning, and so on, can be trained using datasets called training datasets. The training datasets include data relevant to the task for which the neural network is being trained. In addition, the training datasets include expected results associated with the training data. In a usage example, the training data can include a plurality of facial images along with the expected inferences or results, where the expected results include facial characteristics such as facial expressions and demographic information, image characteristics such as lighting or focus, and the like. The training datasets can include data such as audio data, speech data, image data, or facial image data. The training datasets “train” the neural network to match the correct inferences about the training data. The training can include adjusting weights or biases, adding or removing layers of neurons within the neural network, etc. Generally, the larger the training dataset, the better the neural network can be trained. However, training of the neural networks is only as good as the quality of the training datasets. Since the training datasets are often generated by human experts who view data such as the facial images discussed here, and make inferences about the facial images, the training datasets can be small. Further, since the facial images may or may not include a sufficient number of images representing various demographic groups, the training of the neural network can be inadequate for those demographic groups which could result in bias against making correct inferences associated with those demographic groups.

Bias can be identified within the training dataset by computing a multifactor key performance indicator (KPI). The multifactor KPI can be based on one or more measures and rates, where the measures or rates test the training dataset and the trained neural network to properly classify facial images. The measures and rates are used to determine test precision and test recall. The precision associated with a test can include a fraction of relative instances among a set of instances that are retrieved. The recall associated with the test can include a fraction of the total number of retrieved instances actually retrieved. That is, the precision factor can be associated with the validity of the test or classification results (e.g., the correct inference was drawn), while the recall can be associated with the completeness or thoroughness of the test or classification results (e.g., all results were found). When bias is identified in the training dataset, facial images can be added to the training dataset, where the added facial images represent previously underrepresented demographic groups. The added images can be real images and synthetic images. The added images can “fill in” demographic groups, where the demographic groups include age bands, gender, race, facial coverings, facial hair, etc.

Returning to training, neural network training is based on techniques such as applying “known good” data to the neural network in order to adjust one or more weights or biases, to add or remove layers, etc., within the neural network. The adjusting weights can be performed to enable applications such as machine vision, machine hearing, and so on. The adjusting weights can be performed to determine facial elements, facial expressions, human perception states, cognitive states, emotional states, moods, etc. In a usage example, the facial elements comprise human drowsiness features. Facial elements can be associated with facial expressions, where the facial expressions can be associated with one or more cognitive states. The various states can be associated with an individual as she or he interacts with an electronic device or a computing device, consumes media, travels in or on a vehicle, and so on. The synthetic data for neural network training can use synthetic images for machine learning. The machine learning is based on obtaining facial images for a neural network training dataset. A training dataset can include facial lighting data, facial expression data, facial data, image data, audio data, physiological data, and so on. The images can include video images, still images, intermittently obtained images, and so on. The images can include visible light images, near-infrared light images, etc. An encoder-decoder pair can decompose an image attribute subspace and can produce an image transformation mask. Multiple image transformation masks can be generated, where the transformation masks can be associated with facial lighting, lighting source direction, facial expression, etc.

Facial images for a neural network configuration and a neural network training dataset are obtained. The neural network training dataset is associated with the neural network configuration. The neural network configuration can include neural network layer definition, layer interconnection, activation functions, input and output relationships, and so on. The neural network training dataset associated with the neural network configuration can include various training datasets to be used in the training, or tuning, of the neural network to accomplish its desired function or outcome. The facial images can include facial data, facial lighting data, lighting direction data, facial expression data, facial covering data, and so on. The facial images can be used for training a neural network such as a machine learning neural network. Training data can include facial image data, facial expression data, facial data, voice data, physiological data, and so on. Various components such as imaging components, microphones, sensors, and so on can be used for collecting the facial image data and other data. The imaging components can include cameras, where the cameras can include a video camera, a still camera, a camera array, a plenoptic camera, a web-enabled camera, a visible light camera, a near-infrared (NIR) camera, a heat camera, and so on. The images and/or other data are processed on a neural network. The images and/or other data can be further used for training neural network. The neural network can be trained for various types of analysis including image analysis, audio analysis, physiological analysis, and the like. The facial images are partitioned into multiple subgroups, where the multiple subgroups represent demographics with potential for biased training. The subgroups can include age bands, race, gender, facial hair, facial coverings, etc. A multifactor key performance indicator (KPI) is calculated per image. The calculating is based on analyzing performance of two or more image classifier models. The image classifier models can include binary classifier models where the binary classifier model can be used to infer whether the face within a facial image is a member or is not a member of a demographic group. The neural network configuration and the neural network training dataset can be promoted to a production neural network, where the promoting is based on the multifactor key performance indicator. The multifactor key performance indicator (KPI) is used to identify bias in the training dataset. The multifactor KPI can also be used to identify “non-bias” or negative bias in the training dataset. Identified bias precludes promotion of the neural network and training dataset to the production neural network, while identified non-bias allows promotion to the production neural network. Thus, the neural network training dataset that is promoted enables neural network bias mitigation.

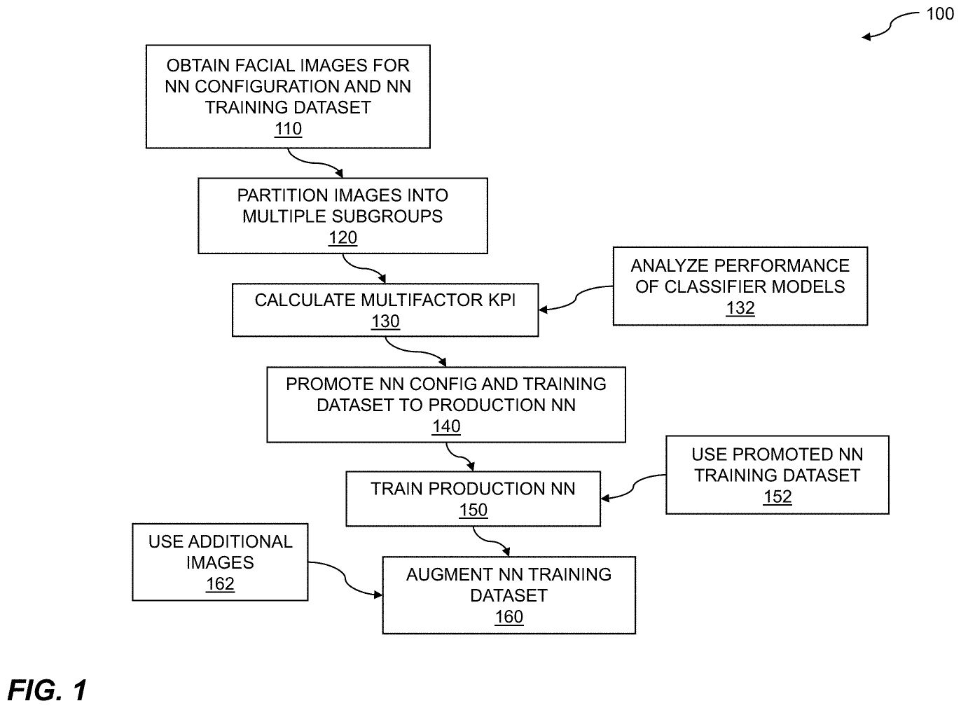

FIG. 1 is a flow diagram for neural network training with bias mitigation. The neural network training with bias mitigation enables machine learning. Bias mitigation is accomplished by identifying bias within the training dataset, using a multifactor key performance indicator, and augmenting the training dataset to overcome the bias. Facial images for a neural network and training dataset are obtained. The facial images are partitioned into multiple subgroups, where the multiple subgroups represent demographics with potential for biased training. A multifactor key performance indicator (KPI) is calculated per image, where the calculating is based on analyzing performance of two or more image classifier models. The multifactor KPI identifies bias or non-bias in the training dataset. The neural network and training dataset is promoted to a production neural network, where the promoting is based on the multifactor key performance indicator.

The flow 100 includes obtaining facial images 110 for a neural network configuration and a neural network training dataset. The facial images can include facial images that represent a diversity of demographic groups. In embodiments, the neural network configuration can include a neural network topology. The neural network topology describes numbers of layers and neurons, interconnections between layers and neurons, feed-forward and feedback data flows, etc. In embodiments, the training dataset includes facial images. The demographic groups can include groups based on age bands; facial hair such as a beard or mustache; ethnicity; gender; facial coverings such as glasses, an eyepatch, or a veil; seat location within a room or vehicle; and so on. The facial images can include facial images that are uploaded by a user, downloaded over a network from a database, and so on. In embodiments, the obtained facial images can further include cognitive state data, audio data such as a voice data, and the like. In embodiments, the facial images that are obtained include facial images of children, teens, young adults, adults, hirsute males, veiled females, and so on. The obtaining facial image data can be based on using one or more cameras to capture images of one or more individuals. The images can contain the facial data. The camera or cameras can include a webcam, where a webcam can include a video camera, a still camera, a thermal imager, a CCD device, a phone camera, a three-dimensional camera, a depth camera, a light field (plenoptic) camera, multiple webcams used to show different views of a person, or any other type of image capture apparatus that can allow captured data to be used in an electronic system. The camera can be coupled to an electronic device such as a computer, a laptop computer, a tablet computer, a personal digital assistant, a smartphone, and so on.

The flow 100 includes partitioning the facial images into multiple subgroups 120, where the multiple subgroups represent demographics with potential for biased training. Discussed throughout, the subgroups can be based on age bands, facial hair, ethnicity, etc. The age bands can include 0-17 years, 18-24, 25-34, 35-44, 45-54, 55-64, 65+, and unknown. The facial hair can include presence of or absence of a beard or a mustache. The ethnicity can include African, Caucasian, East Asian, South Asian, or unknown. The gender can include female, male, or unknown. The facial coverings can include the presence of or absence of eyeglasses, an eyepatch, a veil, and the like. Further demographic information can include income level, religion, educational level, geographic location, etc.

The flow 100 includes calculating a multifactor key performance indicator (KPI) 130 per image. The multifactor KPI can be used to evaluate or measure the effectiveness of a dataset, such as a training dataset used to train a neural network to make unbiased inferences. The multifactor KPI tests the training dataset of facial images for bias or non-bias. In embodiments, the multifactor key performance indicator (KPI) can identify bias in the training dataset. The multifactor KPI can be based on measures and rates. In embodiments, the multifactor KPI comprises an F-measure, an ROC-AUC measure, a precision measure, a recall/true positive rate, a false positive rate, a total number of videos measure, a number of positive videos measure, a number of positive frames measure, or a number of negative frames measure. The measures and rates can be based on detecting true positives, detecting false positives, detecting true negatives, and detecting false negatives. The multifactor KPI can also be based on statistical measures. In embodiments, the multifactor KPI can include an equal odds or equal opportunity measure. The multifactor KPI can be applied to identifying training dataset bias or non-bias across multiple demographics. In embodiments, the multifactor KPI identifies models that generalize across one or more of the demographics. In the flow 100, the calculating can be based on analyzing 132 performance of two or more image classifier models. The classifier models can include binary classifier models, where a binary classifier model determines whether a facial image is a member or is not a member of a given class. The class can include a demographic group.

The flow 100 includes promoting the neural network configuration and training dataset 140 to a production neural network, where the promoting is based on the multifactor key performance indicator. The production neural network is provided with unknown data, where the unknown data includes facial images that the neural network has not encountered previously and for which no expected results are known a priori. Recall that the multifactor KPI can be used to identify bias or non-bias in the training dataset. In embodiments, identified bias can preclude promotion to the production neural network. When bias is identified in the training dataset, bias mitigation techniques can be applied. In other embodiments, identified non-bias can allow promotion to the production neural network. The non-bias in the training dataset implies that the neural network can make unbiased or at least less biased inferences about facial images processed by the neural network. In embodiments, the two or more image classifier models operate on the multiple subgroups of facial images.

The flow 100 further includes training 150 the production neural network. The training the production neural network can include adjusting weights, biases, etc., within the neural network based on one or more successful inference rates, one or more error rates, and the like. The flow 100 includes using the neural network training dataset 152 that was promoted. The promoted neural network training dataset can include the original training dataset, the edited or adjusted training dataset, and so on. In embodiments, the neural network training dataset that was promoted can enable bias mitigation. The flow 100 further includes augmenting 160 the neural network training dataset. The augmenting the neural network training dataset can include adding data such as facial image data. The augmenting can include adding further expected results, fine-tuned expected results, etc.

In the flow 100, the augmenting can be accomplished using additional images 162. The additional images can include images of underrepresented demographic groups. The additional images can include facial images of more young people, more old people, more images representing unknown ages, etc. The additional images can include images of different facial hair styles; different eyeglass sizes, colors, and shapes; different types of veils; a variety of facemasks; and the like. The additional images can be processed, partitioned, etc. In embodiments, the additional images can be processed to produce a further multifactor KPI. The further multifactor KPI can be used to test measures and rates for the additional images. In embodiments, the additional images can be promoted based on the further multifactor KPI. The further multifactor KPI can be used to identify non-bias in the additional images. In embodiments, the additional images can provide neural network training dataset bias mitigation. Various types of images can be included in the additional images. In embodiments, the additional images can include synthetic images. The synthetic images can include computer generated (CG) images. In embodiments, the synthetic images can be generated based on a bias in the neural network training dataset. The synthetic images can be generated to “fill in” a demographic group such as an age band, an ethnicity, gender, etc. Various techniques can be used to generate the synthetic images. In embodiments, the additional images can be generated using a generative adversarial network (GAN). Other types of images can be included in the additional images. In embodiments, the additional images can include real images from a specific demographic. The specific demographic can include an age band, ethnicity, facial covering, etc. In embodiments, the additional images can include real images containing a specific facial characteristic. The facial characteristic can include a facial marking such as a tattoo, a scar, etc. In embodiments, the specific facial characteristic can include facial expressions. The facial expressions can include smiles, frowns, smirks, neural expressions, and the like. Other characteristics for providing additional images can be considered. In embodiments, the additional images can include real images containing a specific image characteristic. An image characteristic can be associated with a quality of the image. In embodiments, the image characteristic can include lighting, focus, facial orientation, or resolution.

Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on. Various embodiments of flow 100, or portions thereof, can be used for a processor-implemented method for machine learning.

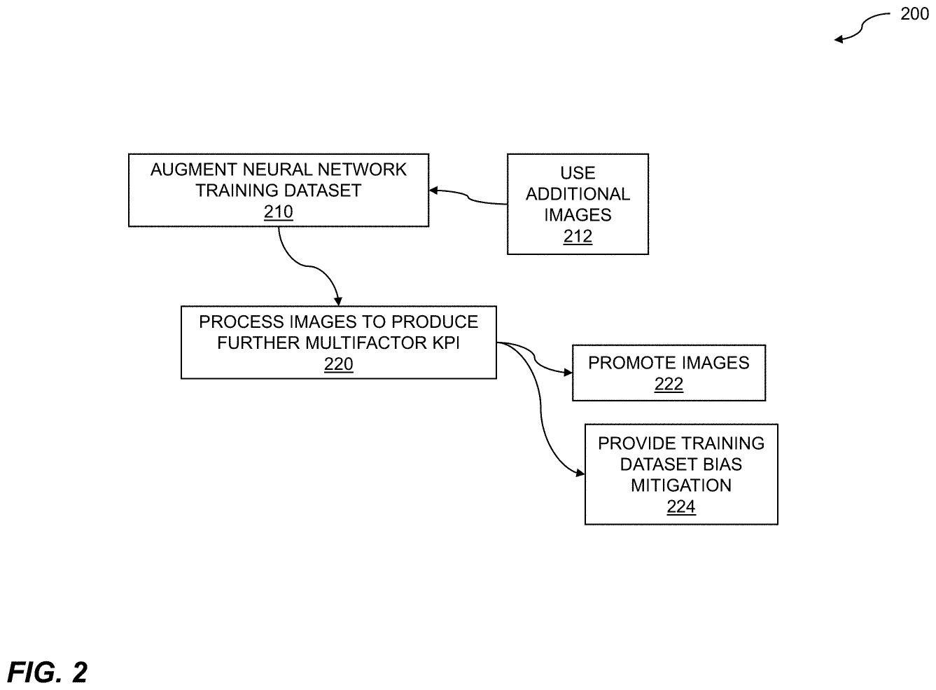

FIG. 2 is a flow diagram for augmenting. When bias is detected within a training dataset or a neural network, augmentation techniques can be used to mitigate the bias. The augmenting can include supplementing the training dataset with additional images such as facial images that represent underrepresented demographic groups. The augmented training dataset can be used to further train the neural network to mitigate the bias. Augmenting enables neural network training with bias mitigation. Facial images for a neural network and training dataset are obtained, and the facial images are partitioned into multiple subgroups. A multifactor key performance indicator (KPI) is calculated per image, and the neural network and training dataset is promoted to a production neural network. The promoting is based on the multifactor key performance indicator.

The flow 200 includes augmenting 210 the neural network training dataset. Discussed throughout, bias can be identified within a dataset such as a training dataset, or a neural network such as a machine learning neural network, based on calculating a multifactor KPI. The calculating of the multifactor KPI can be based on analyzing performance of classifier models, where the classifier models can be used “classify” a facial image. Classification of the facial image, which is often a binary classification of the image (e.g., is or is not within a class), can be used to classify the facial image as a member of not a member of an age band, a racial group, and the like. The augmenting the neural network training dataset can accomplish bias mitigation. In the flow 200, the augmenting can include using additional images 212. Images can both include real images and computer generated or synthetic images. In embodiments, the additional images can include synthetic images. The synthetic images can be generated using one or more neural networks. In embodiments, the synthetic images can be generated based on a bias in the neural network training dataset. That is, the synthetic images can be generated to represent a desired age, race, facial expression, and so on. In other embodiments, the additional images can be generated using a generative adversarial network (GAN). Within a GAN, a generator network generates synthetic images and a discriminator network tries to detect that the images are synthetic. By playing the two networks against each other as adversaries, the generator network generates improved synthetic images which the discriminator network cannot differentiate from real images. In further embodiments, the additional images can include real images from a specific demographic. The specific demographic can include an age band, a gender, a race, etc. In embodiments, the additional images can include real images containing a specific facial characteristic such as facial expressions.

In the flow 200, the additional images are processed 220 to produce a further multifactor KPI. The further multifactor KPI can be used in addition to multifactor KPIs calculated previously, or can be used in place of the previously calculated KPIs. In embodiments, the further multifactor KPI can include an F-measure, an ROC-AUC measure, a precision measure, a recall/true positive rate, a false positive rate, a total number of videos measure, a number of positive videos measure, a number of positive frames measure, or a number of negative frames measure. These various rates and measures just presented can be used to measure or test the effectiveness of the further multifactor KPI to detect bias within the training dataset or the neural network. The KPI can be based on statistical measures. In other embodiments, the multifactor KPI can include an equal odds or equal opportunity measure. The further multifactor KPI that is calculated from the augmented training dataset can be used to identify models such as classifier models. In embodiments, the multifactor KPI identifies models that generalize across one or more of the demographics. In the flow 200, the additional images can be promoted 222 based on the further multifactor KPI. The promoting of the additional images can include promoting the images to a training dataset. In the flow 200, the additional images can provide neural network training dataset bias mitigation 224. The training dataset bias mitigation can be accomplished using additional images that increase numbers of images for previously underrepresented demographic groups. The demographic groups can include groups based on age band, presence or absence of facial hair or facial coverings, race, and the like.

Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on. Various embodiments of flow 200, or portions thereof, can be used for a processor-implemented method for machine learning.

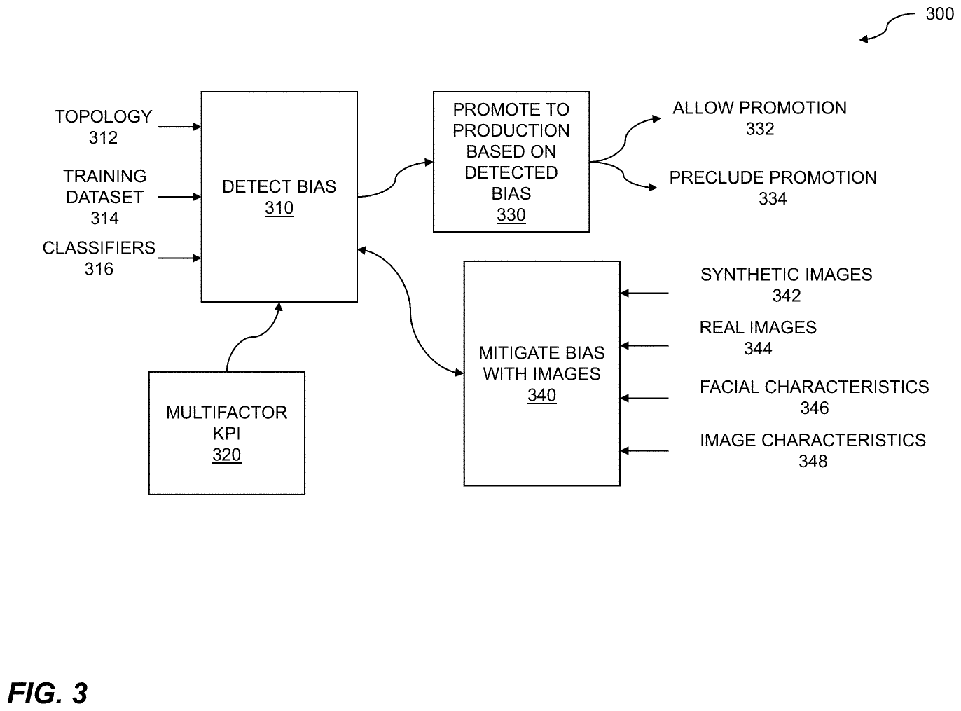

FIG. 3 shows a system block diagram for bias mitigation. Neural networks, such as neural networks for machine learning, can be trained by applying training datasets. The training datasets include data such as facial images and expected results that correspond to those facial images. The facial images can include images of a plurality of people, and the expected results can include facial expressions, moods, emotions, cognitive states, and so on. The training of the neural network is only as good as the training dataset that is used for the training. If the training dataset lacks facial images that represent some demographic groups or people, then the training of the neural network can result in insufficient training for or a bias against such demographic groups. The system block diagram 300 enables neural network training with bias mitigation. Facial images for a neural network and training dataset are obtained. The facial images are partitioned into multiple subgroups, where the multiple subgroups represent demographics with potential for biased training. A multifactor key performance indicator (KPI) is calculated per image, where the calculating is based on analyzing performance of two or more image classifier models. The neural network and training dataset is promoted to a production neural network, where the promoting is based on the multifactor key performance indicator. The multifactor key performance indicator (KPI) identifies bias in the training dataset.

The block diagram 300 can include a detect bias block 310. The detect bias block can be used to detect bias in a neural network topology, within a training dataset, with classifiers. In order to detect bias in a topology, training dataset, or classifiers, information associated with the topology, dataset, or classifiers can be provided to the detect bias block. A neural network topology 312 can describe interconnections of the neural network. The topology can include a number of layers; interconnections between the layers such as fully connected or partially connected; data flow within the neural network such as feed-forward or feedback; and so on. The topology can comprise a neural network configuration. A training dataset 314, as discussed above, includes data such as images and the expected results associated with those images. The expected results associated with the images can be human generated, thus resulting in small training datasets. The classifiers 316 can include classifiers for detecting facial expressions, moods, emotions, cognitive states, etc.

A multifactor key performance indicator (KPI) block 320 can be coupled to the detect bias block 310. The KPI block can calculate a multifactor KPI per image. The image for which the multifactor KPI is calculated can include a test image, a production image, and so on. In embodiments, the multifactor KPI can include an F-measure, an ROC-AUC measure, a precision measure, a recall/true positive rate, a false positive rate, a total number of videos measure, a number of positive videos measure, a number of positive frames measure, or a number of negative frames measure. The measures, rates, and so on, can be used to test the validity of the neural network topology, a training dataset, one or more classifiers, etc. The multifactor KPI can be based on probabilistic techniques. In embodiments, the multifactor KPI can include an equal odds or equal opportunity measure. Some of the multifactor KPI can be successfully applied to more than one demographic group. In other embodiments, the multifactor KPI identifies models that generalize across one or more of the demographics.

The detect bias block 310 can be used to identify bias in facial images used for a training dataset. The detect bias block can also identify a negative or “non-bias” in facial images within the training dataset. The trained neural network and the training dataset can be promoted to a production neural network when non-bias is identified. Bias mitigation can be performed on the training dataset and the neural network when bias is identified. A promote to production block based on detected bias 330 can be coupled to the detect bias block 310. The detect bias block 310 can identify bias and non-bias. In embodiments, the multifactor key performance indicator (KPI) can identify bias in the training dataset. Based on identified bias or non-bias, the neural network and training dataset can be promoted to a production neural network. In embodiments, identified non-bias can allow promotion 332 to the production neural network. The promoting can include classifier models, where the classifier models can be used to detect facial expressions, moods, emotions, cognitive states, etc. The classifier models can further be used to identify demographic groups. Non-bias of the training dataset and the neural network can result when the facial images obtained for neural network training include a plurality of images that represent a range of demographic groups. The demographic groups can be defined by age bands; facial hair such as beards or mustaches; facial coverings such as eyeglasses, eyepatches, or veils; racial or ethnic groups; and the like. In other embodiments, identified bias can preclude promotion 334 to the production neural network. When bias is identified in the training dataset and the neural network, the bias can be ameliorated or mitigated by supplementing the training dataset with further images and characteristics.

The block diagram 300 can include a mitigate bias with images block 340, where the mitigate bias block is coupled to the detect bias block 310. Recall that bias can occur when too few images, such as facial images that represent one or more demographic groups, are present in the training dataset and neural network. The bias can also result when too few images representing facial characteristics and image characteristics are included. The bias mitigation can include adding further images to the training dataset. Further embodiments include augmenting the neural network training dataset using additional images. The additional images can include additional facial images. Since bias or non-bias within the training dataset can be determined based on a multifactor KPI, the additional images can be processed to produce a further multifactor KPI. If bias is no longer identified within the training dataset, then the additional images can be promoted based on the further multifactor KPI. As a result, the additional images can provide neural network training dataset bias mitigation. In embodiments, the additional images can include synthetic images 342. The synthetic images can be generated using one or more neural networks. In embodiments, the synthetic images can be generated using a generative adversarial network (GAN). The GAN can be tuned or adjusted to generate synthetic images to augment images of underrepresented demographic groups. In embodiments, the synthetic images are generated based on a bias in the neural network training dataset. Real images such as real facial images can be used. In embodiments, the additional images can include real images 344 from a specific demographic. The specific demographic can include race, ethnicity, and so on. In addition to including demographic information, the additional images can include real images containing a specific facial characteristic 346. The specific facial characteristic can include hairstyle, facial markings such as tattoos or scars, facial coverings such as facial hair or veils, and so on. In embodiments, the specific facial characteristic can include facial expressions. The facial expressions can include smiles, frowns, smirks, neutral expressions, etc. In further embodiments, the additional images can include real images containing a specific image characteristic 348. The image characteristics can include size of a face within a facial image, image contents such as animals or objects, etc. In embodiments, the image characteristic can include lighting, focus, facial orientation, or resolution.

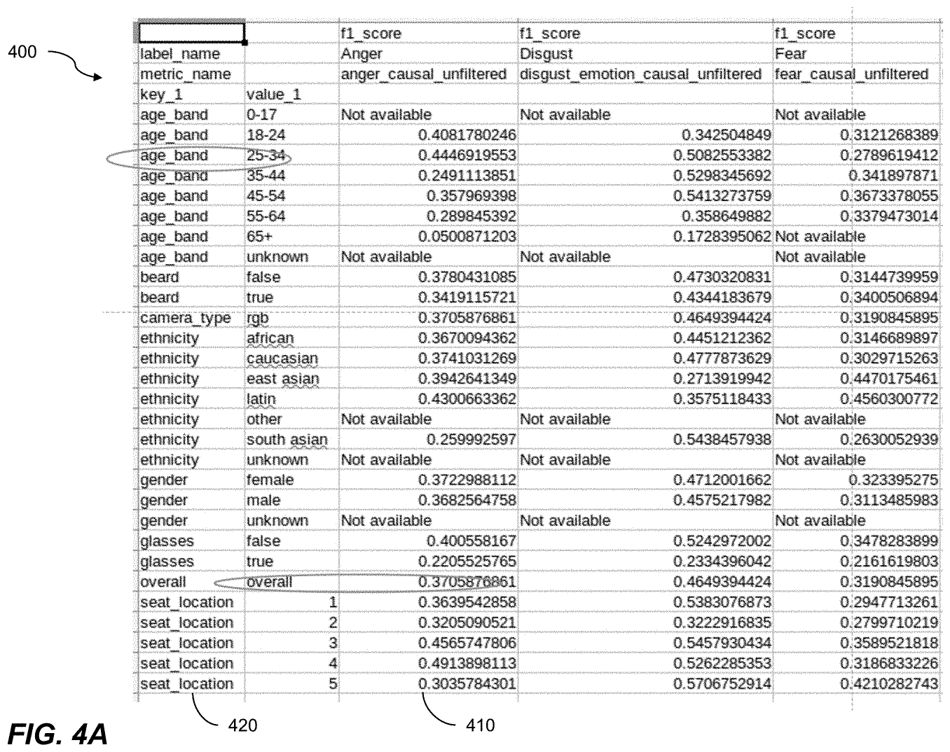

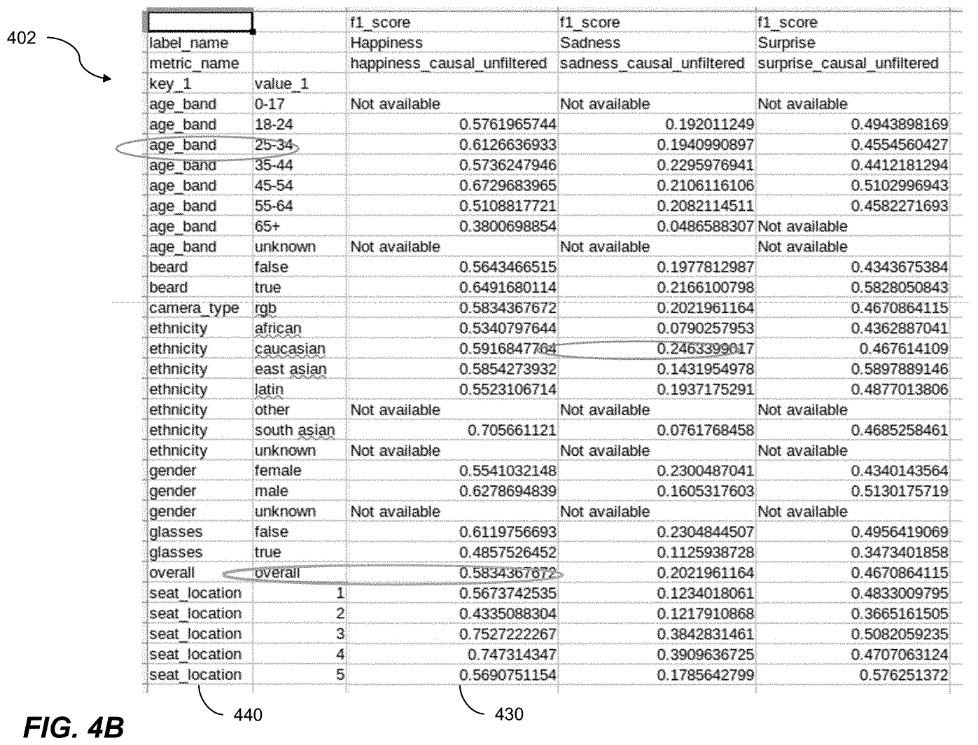

FIG. 4A illustrates an example F1 score. A variety of techniques such as an F score can be used to measure accuracy of a test, a classification, and so on. An F1 score is a type of F score that is based on determining a harmonic mean of parameters associated with the test or classification. The parameters can include test precision and test recall. The F1 score for measuring test accuracy enables neural network training with bias mitigation. Facial images for a neural network and training dataset are obtained. The facial images are partitioned into multiple subgroups, wherein the multiple subgroups represent demographics with potential for biased training. A multifactor key performance indicator (KPI) is calculated per image, wherein the calculating is based on analyzing performance of two or more image classifier models. The neural network and training dataset are promoted to a production neural network, wherein the promoting is based on the multifactor key performance indicator.

A table 400 illustrating an example F1 score for emotions by demographic category is shown. An emotion 410, which can be based on facial expressions, muscle positions, etc., within the facial images, can include anger, disgust, fear, happiness, sadness, and surprise. While three emotions are shown in table 400, an F1 score can be determined for other numbers of emotions. The demographic categories 420 can include an age group indicated by an age band; facial hair; a camera type; ethnicity; gender; facial coverings such as glasses, an eye patch, or a veil; an “overall” category; and a seat location. Other demographic data can include educational level, income level, geographic location, and the like. An F1 score can be calculated, estimated, and so on for each emotion and for each associated demographic. Recall that the F1 score can be calculated for a test or classification based on a precision and a recall associated with the test or classification. The precision associated with a test can include a fraction of relative instances among a set of instances that are retrieved. The recall associated with the test can include a fraction of the total number of retrieved instances actually retrieved. That is, the precision factor can be associated with the validity of the test or classification results, while the recall can be associated with the completeness or thoroughness of the test or classification results.

FIG. 4B illustrates an additional example F1 score. A table 402 illustrating an example F1 score for emotions by demographic category is shown. An emotion 430, which can be based on facial expressions, muscle positions, etc., within the facial images can include anger, disgust, fear, happiness, sadness, and surprise. While three emotions are shown in table 402, an F1 score can be determined for other numbers of emotions. The demographic categories 440 can include an age group indicated by an age band; facial hair; a camera type; ethnicity; gender; facial coverings such as glasses, an eye patch, or a veil; an “overall” category; and a seat location. Other demographic data can include educational level, income level, geographic location, and the like. An F1 score can be calculated, estimated, and so on for each emotion and for each associated demographic. Recall that the F1 score can be calculated for a test or classification based on a precision and a recall associated with the test or classification. The precision associated with a test can include a fraction of relative instances among a set of instances that are retrieved. The recall associated with the test can include a fraction of the total number of retrieved instances actually retrieved. That is, the precision factor can be associated with the validity of the test or classification results, while the recall can be associated with the completeness or thoroughness of the test or classification results.

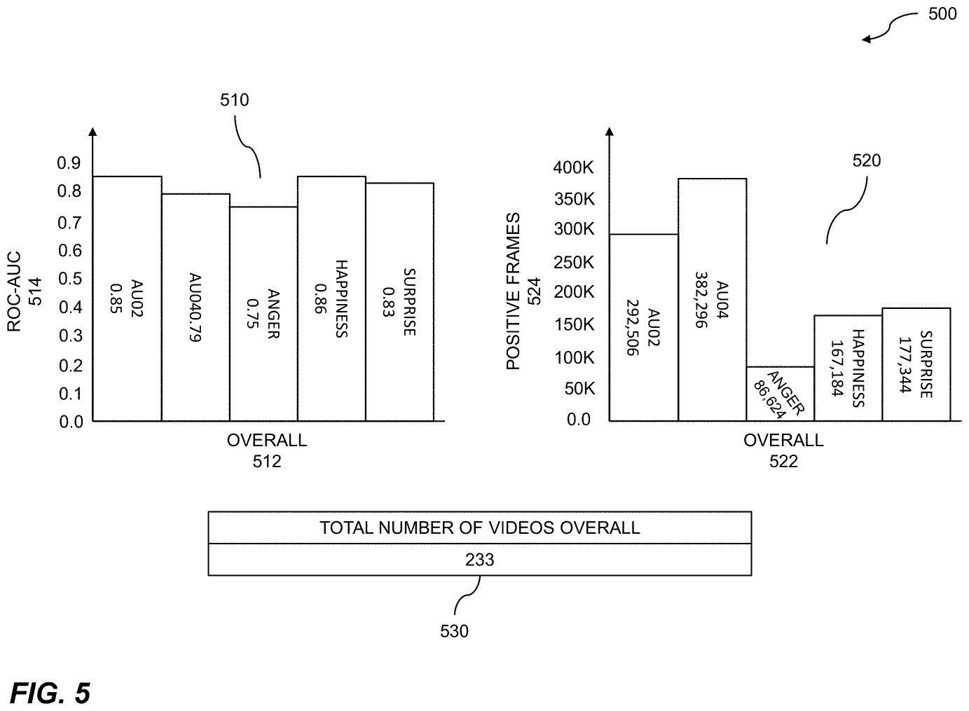

FIG. 5 shows an overall ROC-AUC plot for emotions. Evaluating a performance measurement is vital to determining the effectiveness of training of a neural network such as neural network for machine learning. Such performance evaluation is critical to machine learning problems associated with classification, and particularly to multi-class classification problems. A visualization technique that can be used to evaluate performance is based on plotting a receiver operating characteristics (ROC)—area under the curve (AUC) or ROC-AUC plot. Visualizing performance of a neural network for machine learning using ROC-AUC plotting enables neural network training with bias mitigation. Facial images for a neural network and training dataset are obtained. The facial images are partitioned into multiple subgroups, wherein the multiple subgroups represent demographics with potential for biased training. A multifactor key performance indicator (KPI) is calculated per image, wherein the calculating is based on analyzing performance of two or more image classifier models. The neural network and training dataset are promoted to a production neural network, wherein the promoting is based on the multifactor key performance indicator.

The figure shows ROC-AUC plots for a range of emotions 500, where the emotions can be determined based on one or more action units (AUs). An ROC curve shows classification performance for varying classification thresholds. Increasing a classification threshold classifies fewer images such as facial images as including a given AU or emotion while also reducing false positives. Decreasing the classification threshold classifies more facial images as including the AU or the emotion while also increasing false positives. The performance plot 510 for emotions based on ROC-AUC, shown along axis 514, is represented. The emotions can be based on AU02, AU04, anger, happiness, and surprise, which are shown along overall axis 512. Test sample distribution is shown in 520, with the number of positive frames shown along axis 524. The test samples can include facial images, where the facial images can be based on AU02, AU04, anger, happiness, and surprise, shown along overall axis 522. Table 530 shows the total number of videos, in this example numbering 233, where the videos can include facial images that can be classified using one or more classifiers.

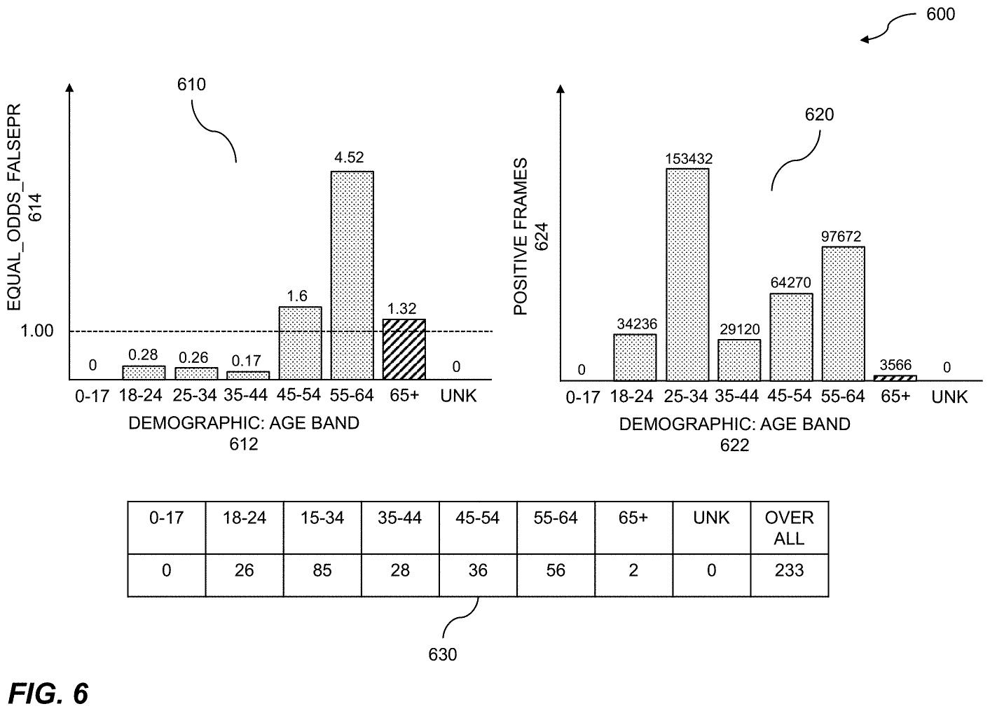

FIG. 6 illustrates example output for a classifier across age bands. Classifier models can be applied to a variety of techniques including calculating a key performance indicator (KPI) for one or more images. Since facial images are obtained and applied to machine learning, the classifier models can be associated with facial expressions. The facial expressions in the images can be coded, such as expressions coded using the Facial Action Coding System (FACS). The codes can be used to describe particular expressions or facial muscle actions and positions that make up expressions, intensities, rates of onset or decay, duration, and so on. The codes can be assigned to action units (AUs). The results of applying the classifier to the images can be plotted for precision, for test data distribution, etc. The output for a classifier is based on neural network training with bias mitigation. Facial images for a neural network and training dataset are obtained. The facial images are partitioned into multiple subgroups, where the multiple subgroups represent demographics with potential for biased training. A multifactor key performance indicator (KPI) is calculated per image, where the calculating is based on analyzing performance of two or more image classifier models. The neural network and training dataset is promoted to a production neural network, wherein the promoting is based on the multifactor key performance indicator.

Output for a classifier plotted across age bands is shown 600. The classifier can include a classifier associated an action unit (AU) defined in the FACS. In embodiments, the action unit can include AU04, where AU04 is associated with a brow lowerer. Plot 610 shows a performance plot for an equal odds false positive rate, shown along axis 614, and test data distribution for an AU04 classifier across age bands, shown along axis 612. In the plot, various age bands are shown such as 0 to 17, 18 to 24, 35 to 44, unknown, and so on. The highest performance is shown for the demographic age band 55 to 64. Other bands show lower performance such as 18 to 24, 25 to 34, etc. Additional bands show negligible statistical support such as 0 to 17 and unknown. Discussed below, the 65+ band also shows negligible statistical support due to only two videos being included in the set of training videos. Plot 620 shows a test sample distribution reference to overall positive frames, shown along axis 624, with respect to an age band demographic, shown along axis 622. The highest positive frames rate is found for the age band 25-34, while lower positive frames rates are found for other bands. Only the age band 65+ shows negligible statistical support, again due to the small number of videos obtained for this age band. Note that the age bands 0 to 17 and “unknown” are based on zero videos so are also considered to show negligible statistical support. The table 630 shows the number of videos available for testing across the various age bands. While most of the age bands are represented by a number of videos and show minimum statistical support, other bands do not. The age band 0 to 17 includes zero videos and the unknown age band includes zero videos, so these age bands show negligible statistical support. The age band 65+ also shows negligible statistical support because only two videos were available for this age band.

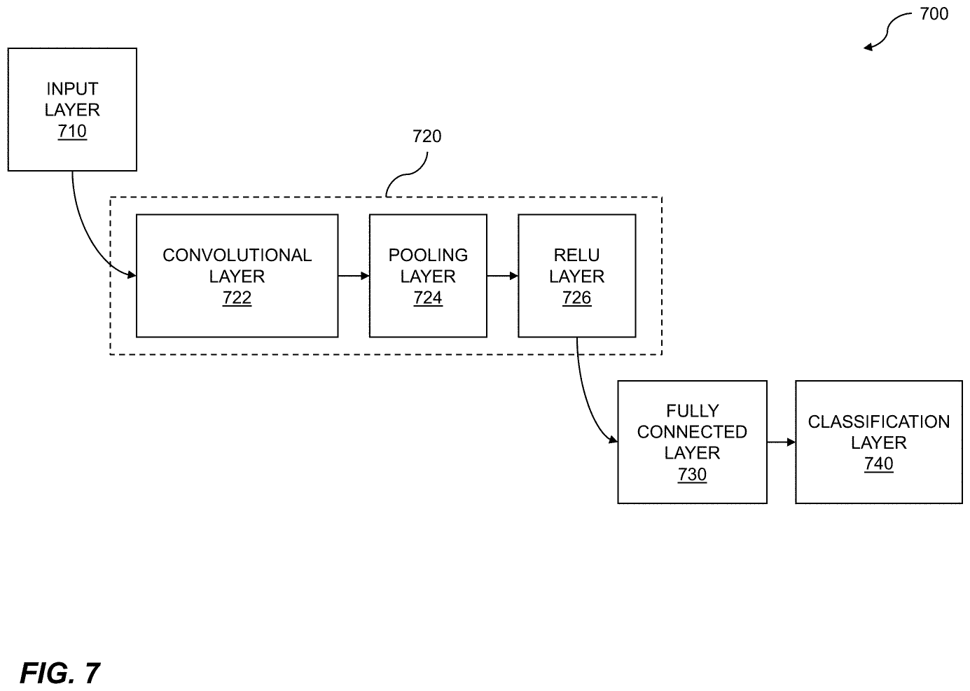

FIG. 7 is an example showing a convolutional neural network (CNN). The convolutional neural network can be used for machine learning or deep learning, where the deep learning can be applied to neural network training with bias mitigation. A multifactor key performance indicator (KPI) can be used to identify bias in a training dataset. The bias can be associated with gender, age, race, and so on. Promotion of a neural network to a production neural network can be precluded or allowed based on whether bias is identified. Facial images are obtained for a neural network and training dataset. The facial images are partitioned into multiple subgroups, where the multiple subgroups represent demographics with potential for biased training. A multifactor key performance indicator (KPI) is calculated per image, where the calculating is based on analyzing performance of two or more image classifier models. The neural network and training dataset is promoted to a production neural network, where the promoting is based on the multifactor key performance indicator.

Emotion analysis, mental state analysis, cognitive state analysis, and so on, are very complex tasks. Understanding and evaluating moods, emotions, mental states, or cognitive states requires a nuanced evaluation of facial expressions or other cues generated by people. Cognitive state analysis is important in many areas such as research, psychology, business, intelligence, law enforcement, and so on. The understanding of cognitive states can be useful for a variety of business purposes, such as improving marketing analysis, assessing the effectiveness of customer service interactions and retail experiences, and evaluating the consumption of content such as movies and videos. Identifying points of frustration in a customer transaction can allow a company to take action to address the causes of the frustration. By streamlining processes, key performance areas such as customer satisfaction and customer transaction throughput can be improved, resulting in increased sales and revenues. In a content scenario, producing compelling content that achieves the desired effect (e.g., fear, shock, laughter, etc.) can result in increased ticket sales and/or increased advertising revenue. If a movie studio is producing a horror movie, it is desirable to know if the scary scenes in the movie are achieving the desired effect. By conducting tests in sample audiences, and analyzing faces in the audience, a computer-implemented method and system can process thousands of faces to assess the cognitive state at the time of the scary scenes. In many ways, such an analysis can be more effective than surveys that ask audience members questions, since audience members may consciously or subconsciously change answers based on peer pressure or other factors. However, spontaneous facial expressions can be more difficult to conceal. Thus, by analyzing facial expressions en masse in real time, important information regarding the general cognitive state of the audience can be obtained.

Analysis of facial expressions is also a complex task. Image data, where the image data can include facial data, can be analyzed to identify a range of facial expressions. The facial expressions can include a smile, frown, smirk, and so on. The image data and facial data can be processed to identify the facial expressions. The processing can include analysis of expression data, action units, gestures, mental states, cognitive states, physiological data, and so on. Facial data as contained in the raw video data can include information on one or more of action units, head gestures, smiles, brow furrows, squints, lowered eyebrows, raised eyebrows, attention, and the like. The action units can be used to identify smiles, frowns, and other facial indicators of expressions. Gestures can also be identified, and can include a head tilt to the side, a forward lean, a smile, a frown, as well as many other gestures. Other types of data including the physiological data can be collected, where the physiological data can be obtained using a camera or other image capture device, without contacting the person or persons. Respiration, heart rate, heart rate variability, perspiration, temperature, and other physiological indicators of cognitive state can be determined by analyzing the images and video data.

Deep learning is a branch of machine learning which seeks to imitate in software the activity which takes place in layers of neurons in the neocortex of the human brain. This imitative activity can enable software to “learn” to recognize and identify patterns in data, where the data can include digital forms of images, sounds, and so on. The deep learning software is used to simulate the large array of neurons of the neocortex. This simulated neocortex, or artificial neural network, can be implemented using mathematical formulas that are evaluated on processors. With the ever-increasing capabilities of the processors, increasing numbers of layers of the artificial neural network can be processed.

Deep learning applications include processing of image data, audio data, and so on. Image data applications include image recognition, facial recognition, etc. Image data applications can include differentiating dogs from cats, identifying different human faces, and the like. The image data applications can include identifying cognitive states, moods, mental states, emotional states, and so on, from the facial expressions of the faces that are identified. Audio data applications can include analyzing audio such as ambient room sounds, physiological sounds such as breathing or coughing, noises made by an individual such as tapping and drumming, voices, and so on. The voice data applications can include analyzing a voice for timbre, prosody, vocal register, vocal resonance, pitch, loudness, speech rate, or language content. The voice data analysis can be used to determine one or more cognitive states, moods, mental states, emotional states, etc.

The artificial neural network, such as a convolutional neural network which forms the basis for deep learning, is based on layers. The layers can include an input layer, a convolutional layer, a fully connected layer, a classification layer, and so on. The input layer can receive input data such as image data, where the image data can include a variety of formats including pixel formats. The input layer can then perform processing such as identifying boundaries of the face, identifying landmarks of the face, extracting features of the face, and/or rotating a face within the plurality of images. The convolutional layer can represent an artificial neural network such as a convolutional neural network. A convolutional neural network can contain a plurality of hidden layers within it. A convolutional layer can reduce the amount of data feeding into a fully connected layer. The fully connected layer processes each pixel/data point from the convolutional layer. A last layer within the multiple layers can provide output which is indicative of cognitive state. The last layer of the convolutional neural network can be the final classification layer. The output of the final classification layer can be indicative of the cognitive states of faces within the images that are provided to the input layer.

Deep networks including deep convolutional neural networks can be used for facial expression parsing. A first layer of the deep network includes multiple nodes, where each node represents a neuron within a neural network. The first layer can receive data from an input layer. The output of the first layer can feed to a second layer, where the latter layer also includes multiple nodes. A weight can be used to adjust the output of the first layer which is being input to the second layer. Some layers in the convolutional neural network can be hidden layers. The output of the second layer can feed to a third layer. The third layer can also include multiple nodes. A weight can adjust the output of the second layer which is being input to the third layer. The third layer may be a hidden layer. Outputs of a given layer can be fed to next layer. Weights adjust the output of one layer as it is fed to the next layer. When the final layer is reached, the output of the final layer can be a facial expression, a cognitive state, a mental state, a characteristic of a voice, and so on. The facial expression can be identified using a hidden layer from the one or more hidden layers. The weights can be provided on inputs to the multiple layers to emphasize certain facial features within the face. The convolutional neural network can be trained to identify facial expressions, voice characteristics, etc. The training can include assigning weights to inputs on one or more layers within the multilayered analysis engine. One or more of the weights can be adjusted or updated during training. The assigning weights can be accomplished during a feed-forward pass through the multilayered neural network. In a feed-forward arrangement, the information moves forward from the input nodes, through the hidden nodes, and on to the output nodes. Additionally, the weights can be updated during a backpropagation process through the multilayered analysis engine.

Returning to the figure, FIG. 7 is an example showing a convolutional neural network 700. The convolutional neural network can be used for deep learning, where the deep learning can be applied to avatar image animation using translation vectors. The deep learning system can be accomplished using a convolutional neural network or other techniques. The deep learning can accomplish facial recognition and analysis tasks. The network includes an input layer 710. The input layer 710 receives image data. The image data can be input in a variety of formats, such as JPEG, TIFF, BMP, and GIF. Compressed image formats can be decompressed into arrays of pixels, wherein each pixel can include an RGB tuple. The input layer 710 can then perform processing such as identifying boundaries of the face, identifying landmarks of the face, extracting features of the face, and/or rotating a face within the plurality of images.

The network includes a collection of intermediate layers 720. The multilayered analysis engine can include a convolutional neural network. Thus, the intermediate layers can include a convolutional layer 722. The convolutional layer 722 can include multiple sublayers, including hidden layers, within it. The output of the convolutional layer 722 feeds into a pooling layer 724. The pooling layer 724 performs a data reduction, which makes the overall computation more efficient. Thus, the pooling layer reduces the spatial size of the image representation to reduce the number of parameters and computation in the network. In some embodiments, the pooling layer is implemented using filters of size 2×2, applied with a stride of two samples for every depth slice along both width and height, resulting in a reduction of 75-percent of the downstream node activations. The pooling layer 724 of the multilayered analysis engine can comprise a max pooling layer. Thus, in embodiments, the pooling layer is a max pooling layer, in which the output of the filters is based on a maximum of the inputs. For example, with a 2×2 filter, the output is based on a maximum value from the four input values. In other embodiments, the pooling layer is an average pooling layer or L2-norm pooling layer. Various other pooling schemes are possible.

The intermediate layers can include a Rectified Linear Units, or RELU, layer 726. The output of the pooling layer 724 can be input to the RELU layer 726. In embodiments, the RELU layer implements an activation function such as f(x)−max (0,x), thus providing an activation with a threshold at zero. In some embodiments, the RELU layer 726 is a leaky RELU layer. In this case, instead of the activation function providing zero when x<0, a small negative slope is used, resulting in an activation function such as f(x)=1(x<0)(ax)+1(x>=0)(x). This can reduce the risk of “dying RELU” syndrome, where portions of the network can be “dead” with nodes/neurons that do not activate across the training dataset. The image analysis can comprise training a multilayered analysis engine using the plurality of images, wherein the multilayered analysis engine can include multiple layers that include one or more convolutional layers 722 and one or more hidden layers, and wherein the multilayered analysis engine can be used for emotional analysis.

The example 700 includes a fully connected layer 730. The fully connected layer 730 processes each pixel/data point from the output of the collection of intermediate layers 720. The fully connected layer 730 takes all neurons in the previous layer and connects them to every single neuron it has. The output of the fully connected layer 730 provides input to a classification layer 740. The output of the classification layer 740 provides a facial expression and/or cognitive state as its output. Thus, a multilayered analysis engine such as the one depicted in FIG. 7 processes image data using weights, models the way the human visual cortex performs object recognition and learning, and is effective for analysis of image data to infer facial expressions and cognitive states.

Machine learning for generating parameters, analyzing data such as facial data and audio data, and so on, can be based on a variety of computational techniques. Generally, machine learning can be used for constructing algorithms and models. The constructed algorithms, when executed, can be used to make a range of predictions relating to data. The predictions can include whether an object in an image is a face, a box, or a puppy, whether a voice is female, male, or robotic, whether a message is legitimate email or a “spam” message, and so on. The data can include unstructured data and can be of large quantity. The algorithms that can be generated by machine learning techniques are particularly useful to data analysis because the instructions that comprise the data analysis technique do not need to be static. Instead, the machine learning algorithm or model, generated by the machine learning technique, can adapt. Adaptation of the learning algorithm can be based on a range of criteria such as success rate, failure rate, and so on. A successful algorithm is one that can adapt—or learn—as more data is presented to the algorithm. Initially, an algorithm can be “trained” by presenting it with a set of known data (supervised learning). Another approach, called unsupervised learning, can be used to identify trends and patterns within data. Unsupervised learning is not trained using known data prior to data analysis.

Reinforced learning is an approach to machine learning that is inspired by behaviorist psychology. The underlying premise of reinforced learning (also called reinforcement learning) is that software agents can take actions in an environment. The actions that are taken by the agents should maximize a goal such as a “cumulative reward”. A software agent is a computer program that acts on behalf of a user or other program. The software agent is implied to have the authority to act on behalf of the user or program. The actions taken are decided by action selection to determine what to do next. In machine learning, the environment in which the agents act can be formulated as a Markov decision process (MDP). The MDPs provide a mathematical framework for modeling of decision making in environments where the outcomes can be partly random (stochastic) and partly under the control of the decision maker. Dynamic programming techniques can be used for reinforced learning algorithms. Reinforced learning is different from supervised learning in that correct input/output pairs are not presented, and suboptimal actions are not explicitly corrected. Rather, online or computational performance is the focus. Online performance includes finding a balance between exploration of new (uncharted) territory or spaces, and exploitation of current knowledge. That is, there is a tradeoff between exploration and exploitation.

Machine learning based on reinforced learning adjusts or learns based on learning an action, a combination of actions, and so on. An outcome results from taking an action. Thus, the learning model, algorithm, etc., learns from the outcomes that result from taking the action or combination of actions. The reinforced learning can include identifying positive outcomes, where the positive outcomes are used to adjust the learning models, algorithms, and so on. A positive outcome can be dependent on a context. When the outcome is based on a mood, emotional state, mental state, cognitive state, etc., of an individual, then a positive mood, emotion, mental state, or cognitive state can be used to adjust the model and algorithm. Positive outcomes can include a person being more engaged, where engagement is based on affect, the person spending more time playing an online game or navigating a webpage, the person converting by buying a product or service, and so on. The reinforced learning can be based on exploring a solution space and adapting the model, algorithm, etc., based on outcomes of the exploration. When positive outcomes are encountered, the positive outcomes can be reinforced by changing weighting values within the model, algorithm, etc. Positive outcomes may result in increasing weighting values. Negative outcomes can also be considered, where weighting values may be reduced or otherwise adjusted.

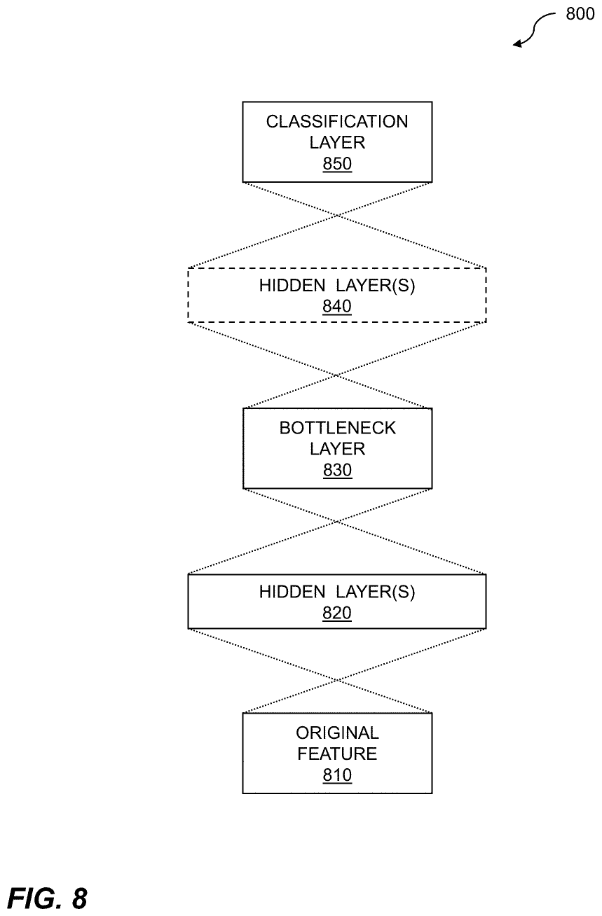

FIG. 8 illustrates a bottleneck layer within a deep learning environment. A bottleneck layer can comprise a layer of a plurality of layers within a deep neural network. The bottleneck layer and the deep neural network can be used for neural network training with bias mitigation. Facial images for a neural network and training dataset are obtained. The facial images are partitioned into multiple subgroups. The multiple subgroups represent demographics with potential for biased training. A multifactor key performance indicator (KPI) is calculated per image. The calculating is based on analyzing performance of two or more image classifier models. The neural network and training dataset is promoted to a production neural network, where the promoting is based on the multifactor key performance indicator. Identified bias precludes promotion to the production neural network, while identified non-bias allows promotion to the production neural network.

Layers of a deep neural network can include a bottleneck layer within a deep learning environment 800. A bottleneck layer can be used for a variety of applications such as facial recognition, voice recognition, cognitive state recognition, emotional state recognition, and so on. The deep neural network in which the bottleneck layer is located can include a plurality of layers. The plurality of layers can include an original feature layer 810. A feature such as an image feature can include points, edges, objects, boundaries between and among regions, properties, and so on. A feature such as a voice feature can include timbre, prosody, vocal register, vocal resonance, pitch, loudness, speech rate, or language content, etc. The deep neural network can include one or more hidden layers 820. The one or more hidden layers can include nodes, where the nodes can include nonlinear activation functions and other techniques. The bottleneck layer can be a layer that learns translation vectors to transform a neutral face to an emotional or expressive face. In some embodiments, the translation vectors can transform a neutral sounding voice to an emotional or expressive voice. Specifically, activations of the bottleneck layer determine how the transformation occurs. A single bottleneck layer can be trained to transform a neutral face or voice to a different emotional face or voice. In some cases, individual bottleneck layers can be trained for a transformation pair. At runtime, once the user's emotion has been identified and an appropriate response to it can be determined (mirrored or complementary), the trained bottleneck layer can be used to perform the needed transformation.

The deep neural network can include a bottleneck layer 830. The bottleneck layer can include a fewer number of nodes than the one or more preceding hidden layers. The bottleneck layer can create a constriction in the deep neural network or other network. The bottleneck layer can force information that is pertinent to a classification, for example, into a low dimensional representation. The bottleneck features can be extracted using an unsupervised technique. In other embodiments, the bottleneck features can be extracted in a supervised manner. The supervised technique can include training the deep neural network with a known dataset. The features can be extracted from an autoencoder such as a variational autoencoder, a generative autoencoder, and so on. The deep neural network can include hidden layers 840. The count of the hidden layers can include zero hidden layers, one hidden layer, a plurality of hidden layers, and so on. The hidden layers following the bottleneck layer can include more nodes than the bottleneck layer. The deep neural network can include a classification layer 850. The classification layer can be used to identify the points, edges, objects, boundaries, and so on, described above. The classification layer can be used to identify cognitive states, mental states, emotional states, moods, and the like. The output of the final classification layer can be indicative of the emotional states of faces within the images, where the images can be processed using the deep neural network.

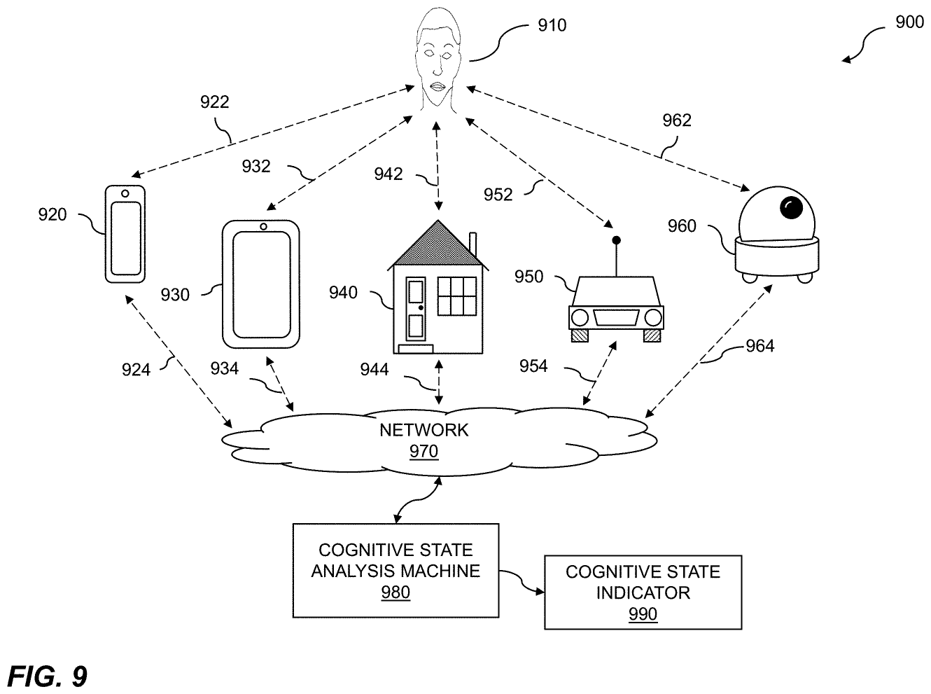

FIG. 9 shows data collection including devices and locations. Data collection using a variety of devices and a variety of locations can enable neural network training with bias mitigation. The bias mitigation can be used to correct for bias, such as demographic bias, in training data. Facial images for a neural network and training dataset are obtained. The facial images are partitioned into multiple subgroups such as demographics subgroups with potential for biased training. A multifactor key performance indicator (KPI) is calculated per image based on analyzing performance of two or more image classifier models. The neural network and training dataset is promoted to a production neural network based on the multifactor key performance indicator.

The multiple mobile devices, vehicles, and locations 900 can be used separately or in combination to collect video data and audio data on a user 910. While one person is shown, the video data and audio data can be collected on multiple people. A user 910 can be observed as she or he is performing a task, experiencing an event, viewing a media presentation, and so on. The user 910 can be shown one or more media presentations, political presentations, social media posts, or another form of displayed media. The one or more media presentations can be shown to a plurality of people. The media presentations can be displayed on an electronic display coupled to a client device. The data collected on the user 910 or on a plurality of users can be in the form of one or more videos, video frames, still images, audio tracks, audio segments, etc. The plurality of videos and audio can be of people who are experiencing different situations. Some example situations can include the user or plurality of users being exposed to TV programs, movies, video clips, social media, social sharing, and other such media. The situations could also include exposure to media such as advertisements, political messages, news programs, and so on. As noted before, video data can be collected on one or more users in substantially identical or different situations and viewing either a single media presentation or a plurality of presentations. The data collected on the user 910 can be analyzed and viewed for a variety of purposes including expression analysis, cognitive state analysis, mental state analysis, emotional state analysis, voice analysis, and so on. The electronic display can be on a smartphone 920 as shown, a tablet computer 930, a personal digital assistant, a television, a mobile monitor, or any other type of electronic device. In one embodiment, expression data and voice data are collected on a mobile device such as a smartphone 920, a tablet computer 930, a laptop computer, or a watch. Thus, the multiple sources can include at least one mobile device, such as a smartphone 920 or a tablet computer 930, or a wearable device such as a watch or glasses (not shown). A mobile device can include a front-facing camera and/or a rear-facing camera that can be used to collect expression data. Sources of expression data can include a webcam, a phone camera, a tablet camera, a wearable camera, and a mobile camera. A wearable camera can comprise various camera devices, such as a watch camera. In addition to using client devices for data collection from the user 910, data can be collected in a house 940 using a web camera or the like; in a vehicle 950 using a web camera, client device, etc.; by a social robot 960, and so on.

As the user 910 is monitored, the user 910 might move due to the nature of the task, boredom, discomfort, distractions, or for another reason. As the user moves, the camera with a view of the user's face can be changed. Thus, as an example, if the user 910 is looking in a first direction, the line of sight 922 from the smartphone 920 is able to observe the user's face, but if the user is looking in a second direction, the line of sight 932 from the tablet computer 930 is able to observe the user's face. Furthermore, in other embodiments, if the user is looking in a third direction, the line of sight 942 from a camera in the house 940 is able to observe the user's face, and if the user is looking in a fourth direction, the line of sight 952 from the camera in the vehicle 950 is able to observe the user's face. If the user is looking in a fifth direction, the line of sight 962 from the social robot 960 is able to observe the user's face. If the user is looking in a sixth direction, a line of sight from a wearable watch-type device, with a camera included on the device, is able to observe the user's face. In other embodiments, the wearable device is another device, such as an earpiece with a camera, a helmet or hat with a camera, a clip-on camera attached to clothing, or any other type of wearable device with a camera or other sensor for collecting expression data. The user 910 can also use a wearable device including a camera for gathering contextual information and/or collecting expression data on other users. Because the user 910 can move her or his head, the facial data can be collected intermittently when she or he is looking in a direction of a camera. In some cases, multiple people can be included in the view from one or more cameras, and some embodiments include filtering out faces of one or more other people to determine whether the user 910 is looking toward a camera. All or some of the expression data can be continuously or sporadically available from the various devices and other devices.

The captured video data and audio data can include facial expressions, voice data, etc., and can be transferred over the network 970. The smartphone 920 can share video and audio using a link 924, the tablet computer 930 using a link 934, the house 940 using a link 944, the vehicle 950 using a link 954, and the social robot 960 using a link 964. The links 924, 934, 944, 954, and 964 can be wired, wireless, and hybrid links. The captured video data and audio data, including facial expressions and voice data, can be analyzed on a cognitive state analysis engine 980, on a computing device such as the video capture device, or on another separate device. The analysis could take place on one of the mobile devices discussed above, on a local server, on a remote server, and so on. In embodiments, some of the analysis takes place on the mobile device, while other analysis takes place on a server device. The analysis of the video data and the audio data can include the use of a classifier. The video data and audio data can be captured using one of the mobile devices discussed above and sent to a server or another computing device for analysis. However, the captured video data and audio data including facial expressions and voice data can also be analyzed on the device which performed the capturing. The analysis can be performed on a mobile device where the videos were obtained with the mobile device and wherein the mobile device includes one or more of a laptop computer, a tablet, a PDA, a smartphone, a wearable device, and so on. In another embodiment, the analyzing comprises using a classifier on a server or another computing device other than the capture device. The analysis data from the cognitive state analysis engine can be processed by a cognitive state indicator 990. The cognitive state indicator 990 can indicate cognitive states, mental states, moods, emotions, etc. In embodiments, the cognitive states can include of one or more of sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, sadness, poignancy, fatigue, drowsiness, or mirth. Analysis can include audio evaluation for non-speech vocalizations including yawning, sighing, groaning, laughing, singing, snoring, and the like.

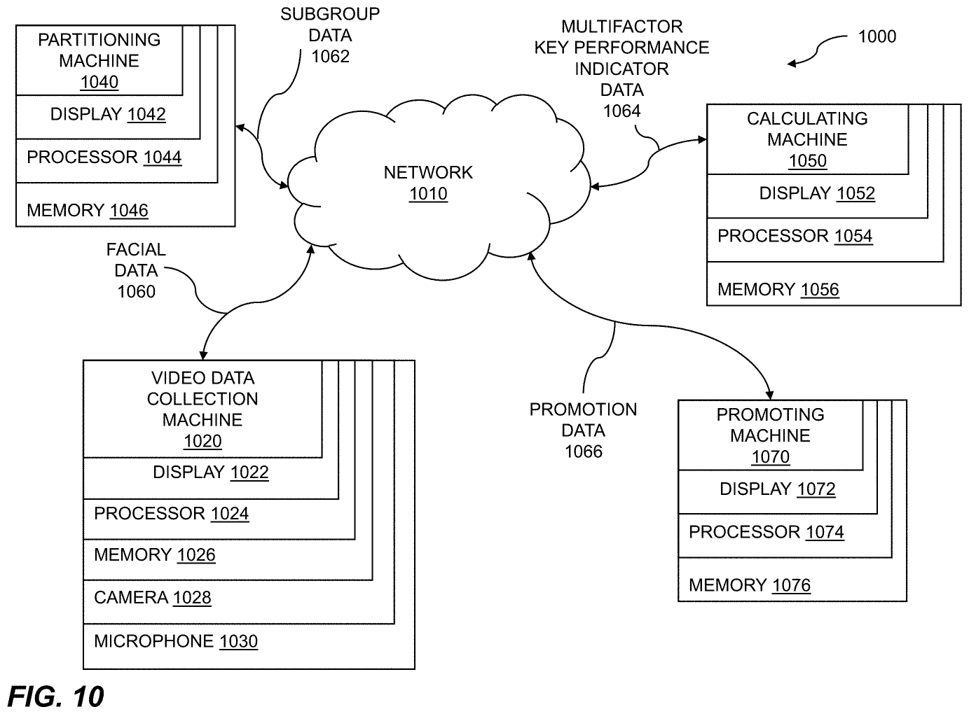

FIG. 10 is a system for machine learning. Machine learning can be accomplished using one or more computers or processors on which a neural network can be executed. An example system 1000 which can perform machine learning is shown. The neural network for machine learning can include a machine learning neural network, a deep learning neural network, a convolutional neural network, a recurrent neural network, and so on. The system 1000 can include a memory which stores instructions and one or more processors attached to the memory, wherein the one or more processors, when executing the instructions which are stored, are configured to: obtain facial images for a neural network and training dataset; partition the facial images into multiple subgroups, wherein the multiple subgroups represent demographics with potential for biased training; calculate a multifactor key performance indicator (KPI) per image, wherein the calculating is based on analyzing performance of two or more image classifier models; and promote the neural network and training dataset to a production neural network, wherein the promoting is based on the multifactor key performance indicator. In embodiments, the multifactor key performance indicator (KPI) can identify bias in the training dataset. The bias, which can include demographic bias, can be based age, gender, gender identity, race, geographic location, etc. The identification of bias can preclude promotion of a neural network to the production neural network, while identification of a non-bias can allow promotion to the production neural network. Other embodiments include augmenting the neural network training dataset using additional images. The additional images can include real images, where the real additional images provide neural network training dataset bias mitigation. The training dataset bias mitigation can be based on selecting or providing real images from a specific demographic. In other embodiments, the additional images comprise synthetic images, where the additional synthetic images can be generated using a generative adversarial network (GAN).

The system 1000 can include one or more video data collection machines 1020 linked to a partitioning machine 1040, a calculating machine 1050, and a promoting machine 1070 via a network 1010 or another computer network. The network can be wired or wireless, a computer network such as the Internet, and so on. Training data such as facial image data 1060, facial element data, demographic data, and so on, can be transferred to the partitioning machine 1040 and to the calculating machine 1050 through the network 1010. The example video data collection machine 1020 shown comprises one or more processors 1024 coupled to a memory 1026 which can store and retrieve instructions, a display 1022, a camera 1028, and a microphone 1030. The camera 1028 can include a webcam, a video camera, a still camera, a thermal imager, a CCD device, a phone camera, a three-dimensional camera, a depth camera, a light field camera, multiple webcams used to show different views of a person, or any other type of image capture technique that can allow captured data to be used in an electronic system. The microphone can include any audio capture device that can enable captured audio data to be used by the electronic system. The memory 1026 can be used for storing instructions, video data including facial images, facial expression data, demographic data, etc. on a plurality of people; audio data from the plurality of people; one or more classifiers; and so on. The display 1022 can be any electronic display, including but not limited to, a computer display, a laptop screen, a netbook screen, a tablet computer screen, a smartphone display, a mobile device display, a remote with a display, a television, a projector, or the like.

The partitioning machine 1040 can include one or more processors 1044 coupled to a memory 1046 which can store and retrieve instructions, and can also include a display 1042. The partitioning machine 1040 can receive the facial image data 1060 and can partition the facial images associated with the facial image data into multiple subgroups. The multiple subgroups can be represented by subgroup data 1062. The demographic data can include age, race, gender or gender identity, geographic location, income levels, religion, and the like. The multiple subgroups can represent demographics with potential for biased training. A potential for biased training of a neural network can exist when data used to train the neural network lacks a breadth and depth of demographic data. In a usage example, training data that comprises facial images of males aged 18-24 would bias the neural network toward young males. The neural network would remain deficient in training for images of older or younger males, females, etc. When the potential for biased training exists, the neural network training data can be augmented using additional images. In embodiments, the additional images can include real images, where the real images can include facial images. The additional images can include real images from a specific demographic. In other embodiments, the additional images can include synthetic images. The synthetic images can include images generated using a neural network. In embodiments, the synthetic images can be generated based on a bias in the neural network training dataset. The bias can be introduced to the neural network in order to generate synthetic images that represent a specific demographic. In embodiments, the additional images can be generated using a generative adversarial network (GAN).

The calculating machine 1050 can include one or more processors 1054 coupled to a memory 1056 which can store and retrieve instructions, and can also include a display 1052. The calculating machine 1050 can receive the facial data 1060 and subgroup data 1062, and can calculate a multifactor key performance indicator (KPI) per image. The calculating can be based on analyzing performance of two or more image classifier models. The two or more classifier models can be used to determine facial regions or facial landmarks; facial expressions; facial coverings such as facial hair, dark glasses, a mask, or a veil; etc. The two or more classifier models can be used to determine demographic data. In embodiments, the multifactor KPI can include an F-measure, an ROC-AUC measure, a precision measure, a recall/true positive rate, a false positive rate, a total number of videos measure, a number of positive videos measure, a number of positive frames measure, or a number of negative frames measure. The multifactor KPI can be based on probability of a model. In embodiments, the multifactor KPI can include an equal odds or equal opportunity measure. The multifactor KPI can further be used to make determinations with respect to models. In other embodiments, the multifactor KPI can identify models that generalize across one or more of the demographics. The calculating machine 1050 can use facial data received from the video data collection machine 1020 to subgroup data 1062 from the partitioning machine 1040. In some embodiments, the calculating machine 1050 receives facial data from a plurality of video data collection machines, aggregates the facial data, processes the facial data or the subgroup data, and so on.

The promoting machine 1070 can include one or more processors 1074 coupled to a memory 1076 which can store and retrieve instructions and data, and can also include a display 1072. The promoting that can be accomplished by the promoting machine can include promoting the neural network and training dataset to a production neural network, wherein the promoting is based on the multifactor key performance indicator data 1064. Whether a neural network is promoted to a production neural network can be determined based on the multifactor KPI. In embodiments, the multifactor key performance indicator (KPI) identifies bias in the training dataset. The bias can include a superfluity of images associated with a demographic subgroup, a paucity of demographic subgroup images, and so on. In embodiments, identified bias can preclude promotion to the production neural network. That is, the neural network requires more training to address the bias. In other embodiments, identified non-bias allows promotion to the production neural network. The promoting machine can determine promotion to a production neural network based on promotion data 1066. The promoting can occur on the promoting machine 1070 or on a machine or platform different from the promoting machine 1070. In embodiments, the promoting of the neural network based on the promoting data occurs on the video data collection machine 1020, the partition machine 1040, or on the calculating machine 1050. As shown in the system 1000, the promoting machine 1070 can receive the multifactor KPI data 1064 via the network 1010, the Internet, or another network, from the video data collection machine 1020, from the partitioning machine 1040, from the calculating machine 1050, or from all. The promoting data can be shown as a visual rendering on a display or any other appropriate display format.

In embodiments, the system 1000 comprises a computer system for robotic control comprising: a memory which stores instructions; one or more processors coupled to the memory wherein the one or more processors, when executing the instructions which are stored, are configured to: obtain facial images for a neural network configuration and a neural network training dataset, wherein the neural network training dataset is associated with the neural network configuration; partition the facial images into multiple subgroups, wherein the multiple subgroups represent demographics with potential for biased training; calculate a multifactor key performance indicator (KPI) per image, wherein the calculating is based on analyzing performance of two or more image classifier models; and promote the neural network configuration and the neural network training dataset to a production neural network, wherein the promoting is based on the multifactor key performance indicator.

In embodiments, the system 1000 can include a computer program product embodied in a non-transitory computer readable medium for machine learning, the computer program product comprising code which causes one or more processors to perform operations of: obtaining facial images for a neural network configuration and a neural network training dataset, wherein the neural network training dataset is associated with the neural network configuration; partitioning the facial images into multiple subgroups, wherein the multiple subgroups represent demographics with potential for biased training; calculating a multifactor key performance indicator (KPI) per image, wherein the calculating is based on analyzing performance of two or more image classifier models; and promoting the neural network configuration and the neural network training dataset to a production neural network, wherein the promoting is based on the multifactor key performance indicator.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for machine learning comprising:
obtaining facial images for a neural network configuration and a neural network training dataset, wherein the neural network training dataset is associated with the neural network configuration;
partitioning the facial images into multiple subgroups, wherein the multiple subgroups represent demographics with potential for biased training;
calculating a multifactor key performance indicator (KPI) per image, wherein the calculating is based on analyzing performance of two or more image classifier models; and
promoting the neural network configuration and the neural network training dataset to a production neural network, wherein the promoting is based on the multifactor key performance indicator.

2. The method of claim 1 wherein the multifactor key performance indicator (KPI) identifies bias in the training dataset.

3. The method of claim 2 wherein identified bias precludes promotion to the production neural network.

4. The method of claim 2 wherein an absence of identified bias allows promotion to the production neural network.

5. The method of claim 1 wherein the multifactor KPI comprises an F-measure, an ROC-AUC measure, a precision measure, a recall/true positive rate, a false positive rate, a total number of videos measure, a number of positive videos measure, a number of positive frames measure, or a number of negative frames measure.

6. The method of claim 1 wherein the multifactor KPI comprises an equal odds or equal opportunity measure.

7. The method of claim 1 wherein the multifactor KPI identifies models that generalize across one or more of the demographics.

8. The method of claim 1 wherein the two or more image classifier models operate on the multiple subgroups of facial images.

9. The method of claim 1 wherein the neural network configuration includes a neural network topology.

10. The method of claim 1 wherein the training dataset includes facial images.

11. The method of claim 1 further comprising training the production neural network, using the neural network training dataset that is promoted.

12. The method of claim 11 wherein the neural network training dataset that is promoted enables bias mitigation.

13. The method of claim 1 further comprising augmenting the neural network training dataset using additional images.

14. The method of claim 13 wherein the additional images are processed to produce a further multifactor KPI.

15. The method of claim 14 wherein the additional images are promoted based on the further multifactor KPI.

16. The method of claim 14 wherein the additional images provide neural network training dataset bias mitigation.

17. The method of claim 13 wherein the additional images comprise synthetic images.

18. The method of claim 17 wherein the synthetic images are generated based on a bias in the neural network training dataset.

19. The method of claim 17 wherein the additional images are generated using a generative adversarial network (GAN).

20. The method of claim 13 wherein the additional images comprise real images from a specific demographic.

21. The method of claim 13 wherein the additional images comprise real images containing a specific facial characteristic.

22. The method of claim 21 wherein the specific facial characteristic includes facial expressions.

23. The method of claim 13 wherein the additional images comprise real images containing a specific image characteristic.

24. The method of claim 23 wherein the image characteristic includes lighting, focus, facial orientation, or resolution.

25. A computer program product embodied in a non-transitory computer readable medium for machine learning, the computer program product comprising code which causes one or more processors to perform operations of:
obtaining facial images for a neural network configuration and a neural network training dataset, wherein the neural network training dataset is associated with the neural network configuration;
partitioning the facial images into multiple subgroups, wherein the multiple subgroups represent demographics with potential for biased training;
calculating a multifactor key performance indicator (KPI) per image, wherein the calculating is based on analyzing performance of two or more image classifier models; and
promoting the neural network configuration and the neural network training dataset to a production neural network, wherein the promoting is based on the multifactor key performance indicator.

26. A computer system for machine learning comprising:
a memory which stores instructions;
one or more processors coupled to the memory wherein the one or more processors, when executing the instructions which are stored, are configured to:
obtain facial images for a neural network configuration and a neural network training dataset, wherein the neural network training dataset is associated with the neural network configuration;
partition the facial images into multiple subgroups, wherein the multiple subgroups represent demographics with potential for biased training;
calculate a multifactor key performance indicator (KPI) per image, wherein the calculating is based on analyzing performance of two or more image classifier models; and
promote the neural network configuration and the neural network training dataset to a production neural network, wherein the promoting is based on the multifactor key performance indicator.
